(19) United States
(12) Patent Application Publication
(10) Pub. No.: US 2006/0082572 A1
(43) Pub. Date: Apr. 20, 2006

(54) Inferring of associative constraints and supporting objects for 3D curves

(76) Inventors: Dirk J. Baardse, Geldermalsen (NL); Avick Chakrborty, Pune (IN); Avijit Sen, Pune (IN); Girish Pasad, Pune (IN)

Correspondence Address: UGS CORP., 5800 GRANITE PARKWAY, SUITE 600, PLANO, TX, 75024, US

(21) Appl. No.: 11/226,916

(22) Filed: Sep. 14, 2005

Related U.S. Application Data
(60) Provisional application No. 60/609,571, filed on Sep. 14, 2004.

(51) Int. Cl. G06T 15/00

(52) U.S. Cl. 345/419

(57) ABSTRACT

One or more embodiments of the presently preferred invention provides a method and a computer-program product for generating a curve on a three-dimensional axis. The curve is generated from a fixed number of inputs or constraints. The combination of constraint types determines the type of curve. Further, the curve is associative to its inputs such that when the reference geometry changes, the constraint is updated, and the curve will modify to reflect the associated input modifications.

### PRIORITY OF APPLICATION

The present application claims priority of U.S. provisional application Ser. No. 60/609,571 filed Sep. 14, 2004, which is incorporated herein by reference.

### TECHNICAL FIELD

This invention relates generally to design of curves in a three-dimensional environment. More particularly, the invention relates to a method for inferring associative constraints and supporting objects for three-dimensional curves.

### BACKGROUND

The computer has greatly affected essentially all forms of geometric modeling, including the graphical editing and computer aided design and drafting (CAD) tools. Some simpler geometric modeling computer program products are two dimensional, providing only length and width dimensions of objects, while more complex and powerful computer program products provide three dimensional editing and visualization.

Lines, curves, arcs, and splines are used in three-dimensional (3D) computer aided design (CAD) systems and vector graphic systems for surfaces, edges, and other geometric shapes. In the 3D CAD systems of today, a CAD designer must first choose a 3D curve type to create by selecting it from a commonly limited selection.

There is a need for a function that can create all possible 3D curves, including lines, arcs and circles, where the resulting 3D curve is associative to its inputs, while maintaining operability and not becoming over burdensome to the end user.

Except as may be explicitly indicated otherwise, the following definition applies:

normal, or surface normal: a three-dimensional vector that is perpendicular to a flat surface or plane.

### SUMMARY

To overcome the limitations in the prior art described above and to overcome other limitations that will become apparent upon reading and understanding the present specification, the present invention discloses a method for generating a curve on a three-dimensional axis, comprising the steps of: receiving from a user at least one constraint, interpreting at least one supporting object derived from said at least one constraint, associating said at least one constraint with at least one reference geometry, and defining a curve extent. The at least one supporting object is displayed and revisable by said user. There is one supporting object. The supporting object is a plane. The interpreting is at least one of inferred or defined.

Another advantage of the present invention is a computer-program product tangibly embodied in a machine readable medium to perform a method for generating a three-dimensional curve, comprising: instructions for receiving from a user at least one constraint, instructions for interpreting at least one supporting object derived from said at least one constraint, instructions for associating said at least one constraint with at least one reference geometry, and instructions for defining a curve extent. The supporting object is displayed and revisable by said user. There is only one supporting object. There is only one supporting object and it is a plane. The interpreting is at least one of inferred or defined.

And another advantage of the present invention is a data processing system having at least a processor and accessible memory, comprising: means for receiving from a user at least one constraint, means for interpreting at least one supporting object derived from said at least one constraint, means for associating said at least one constraint with at least one reference geometry, and means for defining a curve extent. The at least one supporting object is displayed and revisable by said user. There is one supporting object. The supporting object is a plane. The interpreting is at least one of inferred or defined.

Yet another advantage of the present invention is a method for generating a three-dimensional curve, wherein said curve is one of a line, an arc and a circle, comprising the steps of: receiving from a user at least one constraint, wherein said at least one constraint is associated with at least one reference geometry, and said at least one constraint is one of inferred and defined, creating a supporting plane that is displayed and revisable by the user from said at least one constraint, wherein said supporting plane is one of inferred and defined, and defining a curve extent.

And yet another advantage of the present invention is a computer-program product tangibly embodied in a machine readable medium to perform a method for generating a three-dimensional curve, wherein said curve is one of a line, an arc and a circle, comprising: instructions for receiving from a user at least one constraint, wherein said at least one constraint is associated with at least one reference geometry, and said at least one constraint is one of inferred and defined, instructions for creating a supporting plane that is displayed and revisable by the user from said at least one constraint, wherein said supporting plane is one of inferred and defined, and instructions for defining a curve extent.

Also another advantage of the present invention is a data processing system having at least a processor and accessible memory, comprising: means for generating a three-dimensional curve, wherein said curve is one of a line, an arc and a circle, comprising the steps of: receiving from a user at least one constraint, wherein said at least one constraint is associated with at least one reference geometry, and said at least one constraint is one of inferred and defined, creating a supporting plane that is displayed and revisable by the user from said at least one constraint, wherein said supporting plane is one of inferred and defined, and defining a curve extent.

And also another advantage of the present invention is a computer data signal for CAD/CAM modeling, said computer data signal comprising code configured to cause a designer to implement on a computer to employ a method comprising: generating a three-dimensional curve, wherein said curve is one of a line, an arc and a circle, comprising the steps of: receiving from a user at least one constraint, wherein said at least one constraint is associated with at least one reference geometry, and said at least one constraint is one of inferred and defined, creating a supporting plane that is displayed and revisable by the user from said at least one constraint, wherein said supporting plane is one of inferred and defined, and defining a curve extent.

The present invention will now be described with reference made to the following Figures that form a part hereof, and which is shown, by way of illustration, an embodiment of the present invention. It is understood that other embodiments may be utilized and changes may be made without departing from the scope of the present invention.

### BRIEF DESCRIPTION OF THE DRAWINGS

A preferred exemplary embodiment of the present invention will hereinafter be described in conjunction with the appended drawings, wherein like designations denote like elements, and:

FIG. 1 is a block diagram of a computer environment in which the present invention may be practiced;

FIG. 2, a flow chart illustrating three applications of a single curve function, as denoted by I, II, and III;

FIGS. 3a-3c, a series of flowcharts for line creation;

FIGS. 4a-4c, a series of flowcharts for center-based arc/circle creation;

FIGS. 5a-5d, a series of flowcharts for three-point arc/circle creation;

FIG. 6, an indented tree structure illustrating auto-inferring of constraints;

FIG. 7, depicts an illustration of line creation;

FIG. 8a and FIG. 8b, depicts an illustration of creation of a sample center-based arc; and

FIG. 9a, FIG. 9b, and FIG. 9c, depicts an illustration to create a sample 3-Point arc.

### DESCRIPTION OF THE PREFERRED EMBODIMENT

I. Hardware/Software Environment

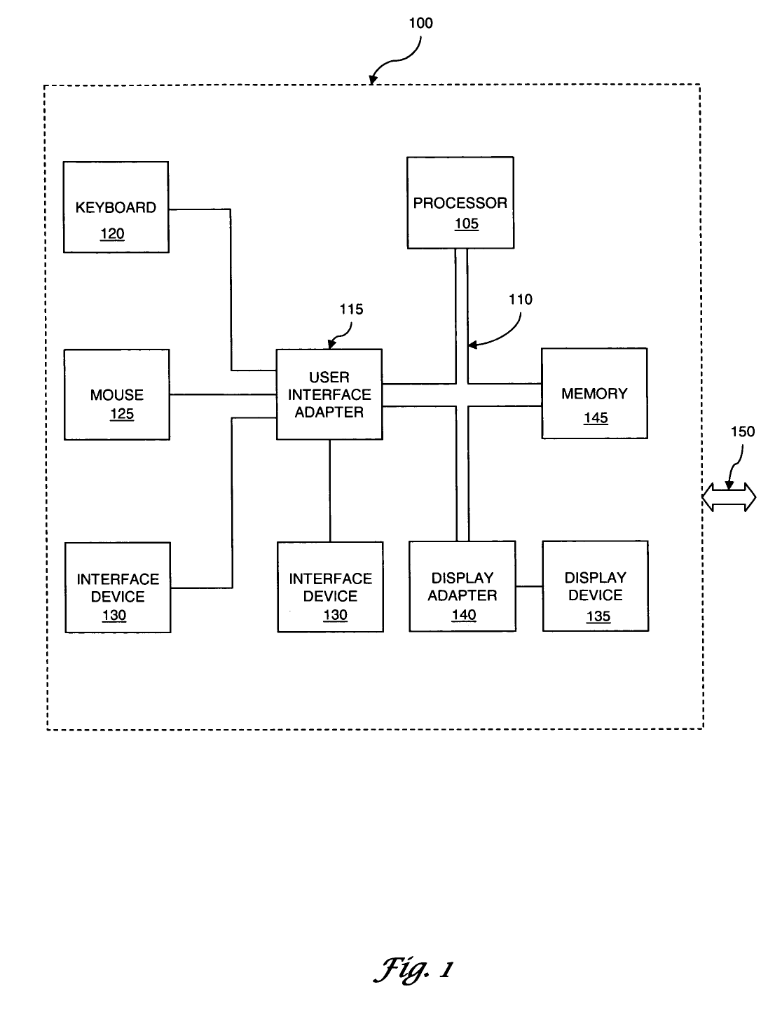

The present invention may be performed in any of a variety of known computing environments. The environment of FIG. 1 comprises a representative conventional computer 100, such as a desktop or laptop computer, including a plurality of related peripheral devices (not depicted). The computer 100 includes a microprocessor 105 and a bus 110 employed to connect and enable communication between the microprocessor 105 and a plurality of components of the computer 100 in accordance with known techniques. The computer 100 typically includes a user interface adapter 115, which connects the microprocessor 105 via the bus 110 to one or more interface devices, such as a keyboard 120, mouse 125, and/or other interface devices 130, which can be any user interface device, such as a touch sensitive screen, digitized pen entry pad, etc. The bus 110 also connects a display device 135, such as an LCD screen or monitor, to the microprocessor 105 via a display adapter 140. The bus 110 also connects the microprocessor 105 to memory 145, which can include ROM, RAM, etc.

The computer 100 communicates via a communications channel 150 with other computers or networks of computers. The computer 100 may be associated with such other computers in a local area network (LAN) or a wide area network (WAN), or it can be a client in a client/server arrangement with another computer, etc. All of these configurations, as well as the appropriate communications hardware and software, are known in the art.

Software programming code that embodies the present invention is typically stored in a memory 145 of the computer 100. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

II. Curve Function

The preferred embodiment is practiced utilizing a curve function to create all possible three-dimensional (3D) curves with a fixed number of constraints. It is the combination of various constraints that determines the curve type. Each constraint is associated to a reference geometry, such that when the reference geometry is modified, the associated constraints updates and the formed curve adjusts accordingly. There are three constraint types: radius, tangent, and point. Given there are at most three constraints, with three input types of radius, tangent, and point, the following table illustrates the possible combinations:

TABLE 1

| | 1 | 2 | 3 | 4 | 5 | 6 | 7 |
|---|---|---|---|---|---|---|---|
| Constraint1 | point | point | point | point | point | radius | tangent |
| Constraint2 | point | point | point | tangent | tangent | tangent | tangent |
| Constraint3 | point | ra- | tan- | tangent | radius | tangent | tangent |
| | | dius | gent | | | | |

And since a designer is allowed to define the constraints in any order, the following a table illustrates the possible combinations of constraints utilized in curve creation:

TABLE 2

| Curve Type | Constraint1 | Constraint2 | Constraint3 |
|---|---|---|---|
| 1 | Point | Point | Point |
| 2 | Point | Point | Tangent |
| 3 | Point | Point | Radius |
| 4 | Point | Tangent | Point |
| 5 | Point | Tangent | Tangent |
| 6 | Point | Tangent | Radius |
| 7 | Point | Radius | Point |
| 8 | Point | Radius | Tangent |
| 9 | Tangent | Point | Point |
| 10 | Tangent | Point | Tangent |
| 11 | Tangent | Point | Radius |
| 12 | Tangent | Tangent | Point |
| 13 | Tangent | Tangent | Tangent |
| 14 | Tangent | Tangent | Radius |
| 15 | Tangent | Radius | Point |
| 16 | Tangent | Radius | Tangent |
| 17 | Radius | Point | Point |
| 18 | Radius | Point | Tangent |
| 19 | Radius | Tangent | Point |
| 20 | Radius | Tangent | Tangent |

As evident from Table 2, there are at least twenty curve types available for creation with three constraints, such that to display all twenty choices to the designer would become overly burdensome. Further, lines do not have the radius input, and are therefore defined by only two inputs, point and tangent, and therefore only need two constraints, as discussed more fully below in Section II.A.2.

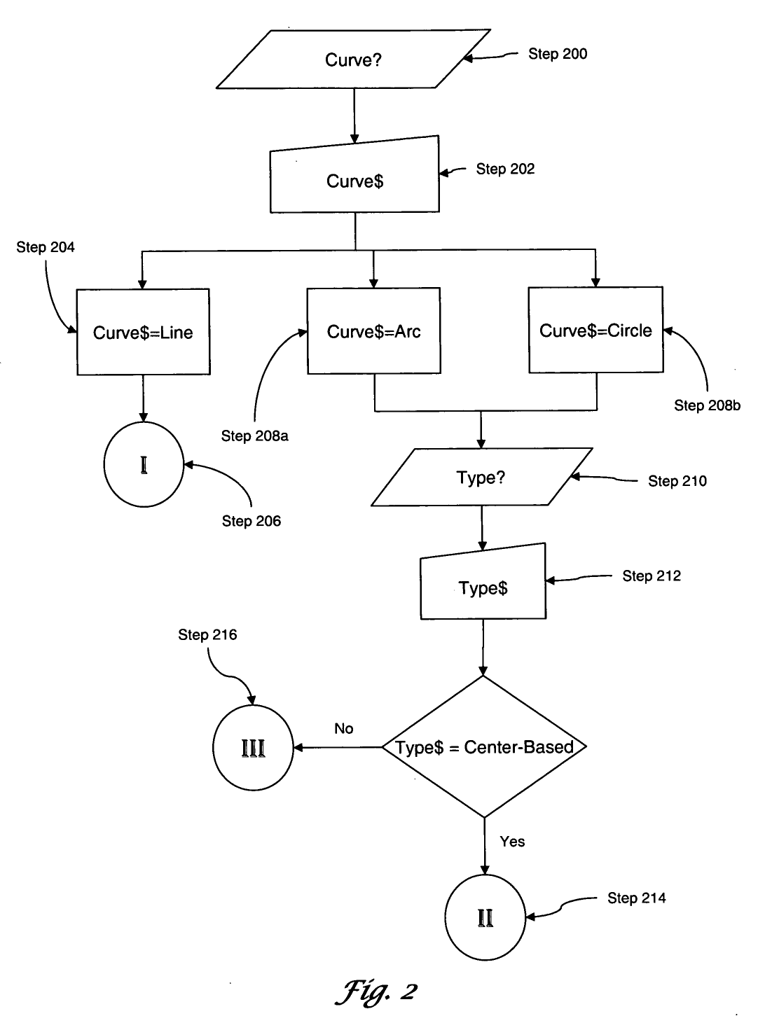

Turning to FIG. 2, a flow chart illustrating three applications of the single curve function, as denoted by I, II, and III, a user designs a curve by first determining whether the intended curve is linear or non-linear (Step 200), and inputs that decision into the computer (Step 202) by use of commonly acceptable means for input. If the curve is linear (Step 204), the preferred embodiment proceeds to I (Step 206). If the curve is non-linear, e.g., an arc or a circle (Step 208a, Step 208b), the user then has to indicate by what means the preferred embodiment will create the non-linear arc/circle (Step 210) by designating a curve create-type, e.g., three-point or center-based. After inputting the curve create-type (Step 212), the preferred embodiment proceeds to II (Step 216) if the curve create-type is Center-Based (Step 214), or to III (Step 220) if the curve create-type is 3-point (Step 218).

A. Line Creation

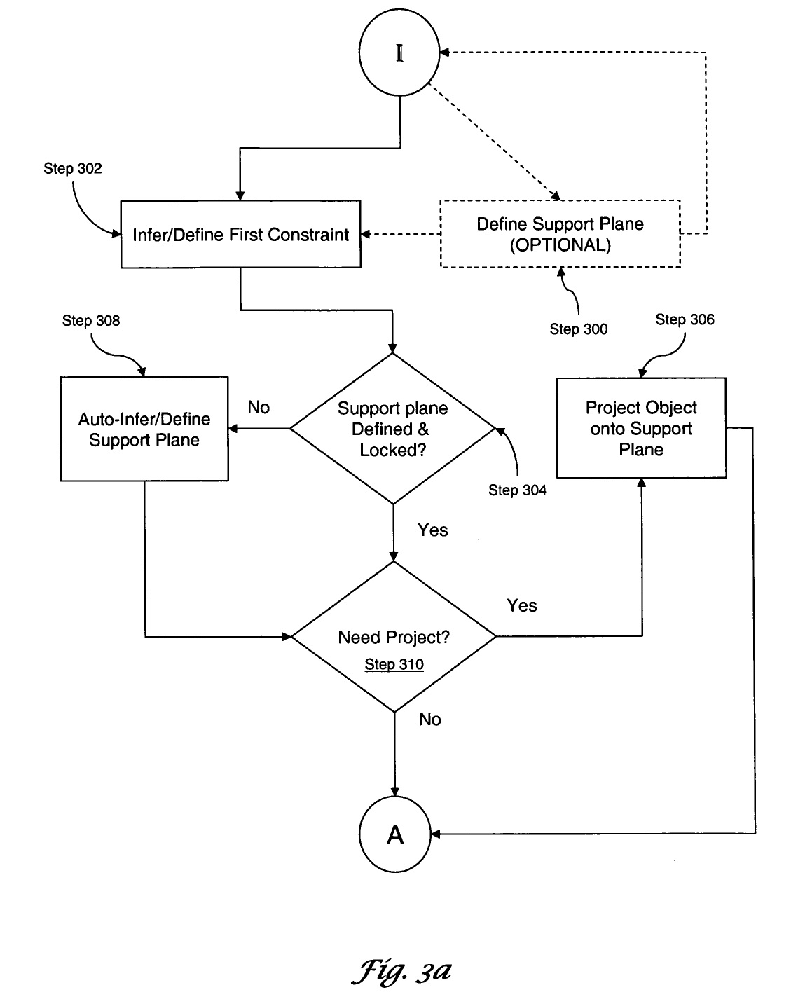

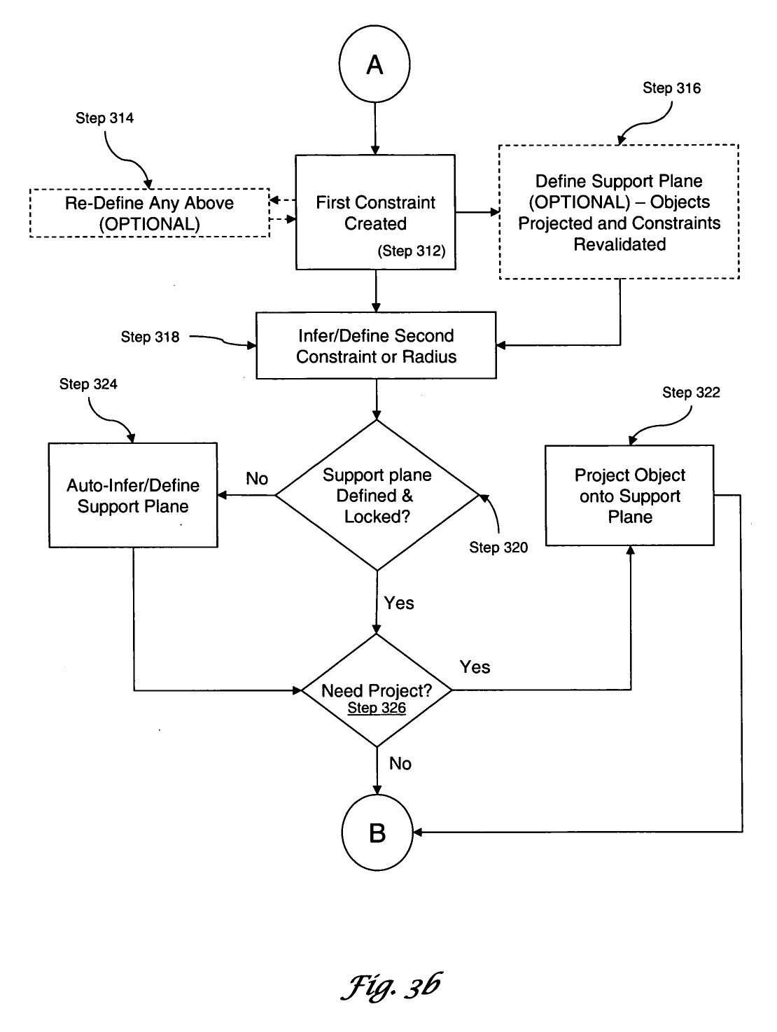

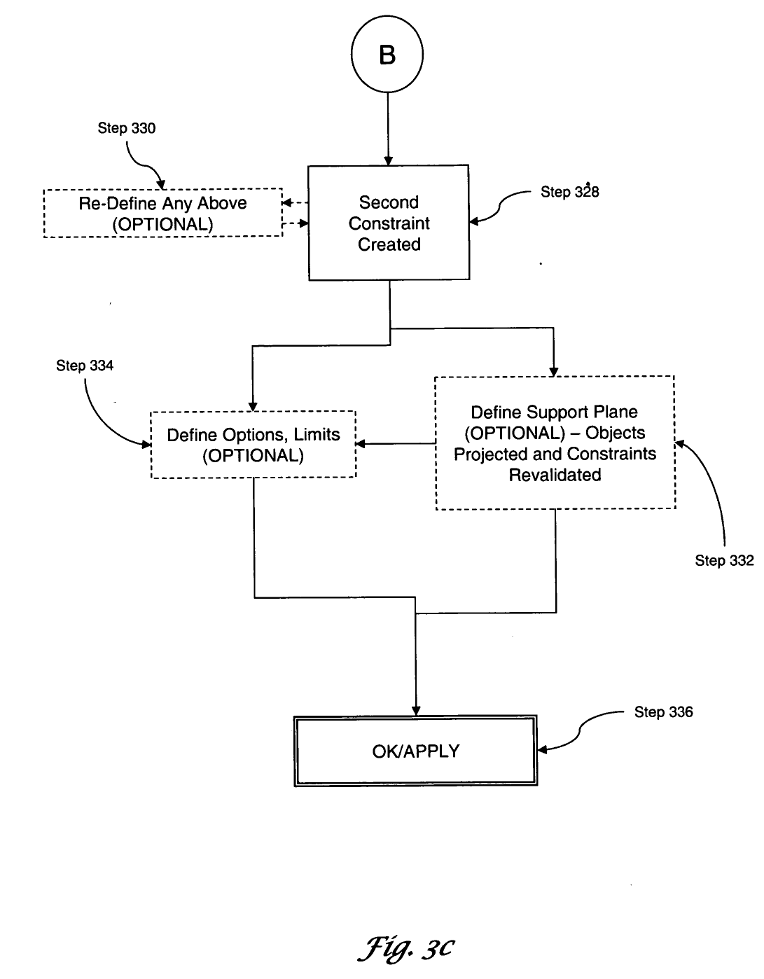

Turning to FIGS. 3a-3c, a series of flow charts for line creation, where line creation includes inferring or defining a plurality of curve components, and those curve components are at least one constraint, and one support plane. Regardless, the curve components can be defined or inferred at any stage of the curve creation that is feasibly possible, and can likewise be edited at anytime before curve creation by the user using commonly understood 3D CAD tools and/or commands. Further, the designer can also define limit values for the length of the created line, where the limit value is a numerical distance or is set to an object selected by the designer.

1. Creating the First Constraint

It is optional to define the support plane at the beginning (Step 300), however a first constraint must initially be inferred or defined (Step 302). Formation of an inferred constraint will be discussed in Section II.D, Auto-Inferred Constraints, infra. And a defined constraint is one that is selected by the user in methods commonly known in the industry for selecting objects, and or features, in 3D CAD programs.

If the support plane is not defined and locked (Step 304), the single curve function auto-infers or defines the support plane (Step 308). The auto-inferring of the support plane after the first constraint is supplied for the line operation, which is illustrated more fully by use of the heuristics in the following decision table, TABLE 3 where the inferred support plane is defined by at least a point and a normal:

TABLE 3

| Constraint | First pick | Inferred support plane |
|---|---|---|
| Point P | 1. Point in space, Existing | Point: Picked point |
| | Point or Point by | Normal: Normal of the principal |
| | coordinates | plane (XY, YZ or ZX) which is |
| | | the most parallel to the screen. |
| | | Projected entity: None |
| | 2. Point on a line or a | Point: Point on a line or a |
| | LinearEdge | linear edge |
| | | Normal: The plane passes |
| | | through the picked line. The |
| | | normal of the plane is closest to |
| | | the normal of the principal |
| | | plane, having the longest |
| | | projection of the line. |
| | | Projected entity: None |
| | 3. Point on an arc or any | Point: Point on an arc |
| | planar curve, or a linear | Normal: Normal of the plane of |
| | curve | the curve |
| | | Projected entity - None |
| | 4. Point on a 3D spline, | Point: Point on a 3D spline |
| | End point of a 3D | Normal: Curve normal at that |
| | spline, Knot point | point |
| | of a 3D spline | Projected entity: None |
| | 5. Point on a 3D face or a | Point: Point on a 3D face |
| | Planar face | Normal: Face normal direction |
| | | at that point |
| | | Projected entity: None |
| Tangent T | 1. Planar object picked. | Point: Point anywhere on the |
| | | curve |
| | | Normal: Normal of the plane of |
| | | the curve. |
| | | Projected entity: None |
| | 2. Non planar object | Cannot infer the plane. A 3d |
| | picked. | curve cannot be picked as the |
| | | first tangent constraint. |

However, it is obvious to those skilled in the art of CAD design how to define a plane utilizing overt selection methods, for example a double mouse button click.

Once the support plane is defined or auto-inferred, or the support plane is defined and locked by the user (Step 304) the function then determines whether it is necessary to project the object onto the support plane (Step 310), and continuing on to actually project the object onto the support plane (Step 306), before the first constraint is created (Step 312). And if no object needs projection onto the support plane, then the single curve function creates the first constraint (Step 312). It is important to note that the user continues to have the option to redefine any of the above defined and/or inferred components (Step 314).

2. Creating the Second Constraint

After the first constraint is created, the user has the option to define the support plane (Step 316), where objects are projected and constraints are revalidated. Should the user not define the support plane, a second constraint or radius is then defined or inferred (Step 318). The defining of the second constraint or radius is accomplished by the same overt method for selection as commonly understood in the industry. And the inference of the second constraint or radius is accomplished by the method discussed at II.D, Auto-Inferred Constraints, infra.

If the support plane is defined and locked (Step 320), the single curve function auto-infers or defines the support plane (Step 324). The auto-inferring of the support plane after the second constraint is supplied for the line operation is illustrated more fully by use of the heuristics in the following decision table, TABLE 4 where P2 is the second point picked, C1 is the first constraint, C2 is the second constraint, and the inferred support plane is defined by at least a point and a normal:

TABLE 4

| | | Inferred plane when first | | Inferred |
|---|---|---|---|---|
| | | constraint is a point | | plane when |
| | | Point on Line or | | first |
| Second | | Point on Linear | | constraint is |
| Constraint Pick | | Edge | All remaining cases | tangent |
| Point P | Point on | 1. If the point lies | 1. If the point lies in | TP |
| | a Line or | in the present | the present | 1. If C1 is |
| | a Linear | inferred plane | inferred plane | planar |
| | Edge | then the | then the support | Point: point |
| | | support plane | plane will remain | on C1 |
| | | will remain | unchanged. | Normal: |
| | | unchanged. | Projected | Normal of |
| | | Projected | entity: None | the plane in |
| | | entity: None | 2. (a) If P1 does not | which C1 |
| | | 2. If P2 does not | lie on C2, | lies. |
| | | lie on C1, then | then support | Projected |
| | | the support | plane will pass | entity: P2 |
| | | plane will pass | through P1 and | 2. If C1 is 3d |
| | | through C1 and | C2. | curve |
| | | P2. | Projected | When the |
| | | Projected | entity: None | first object is |
| | | entity: None | (b) If P1 lies on | a 3d curve, it |
| | | | C2, then | cannot be picked |
| | | | Point: point on | |
| | | | C2 | 3. If C1 is |
| | | | Normal: Plane | linear |
| | | | passes through | In the case |
| | | | C2 and the | of a linear |
| | | | normal of the | line, it |
| | | | plane is closest | cannot be |
| | | | to the normal of | picked linear |
| | | | the principal | curve as a |
| | | | plane, having | tangent. |
| | | | the longest | |
| | | | projection of C2. | |
| | | | Projected | |
| | | | entity: P1 | |
| | All remaining | 1. If the point lies | 1. If the point lies | |
| | cases | in the present | in the present | |
| | | inferred plane | inferred plane | |
| | | then the | then the support | |
| | | support plane | plane will remain | |
| | | will remain | unchanged. | |
| | | unchanged. | 2. Point: First | |
| | | 2. If P2 does not | point | |
| | | lie on C1, then | Normal: Plane | |
| | | the support | passes through | |
| | | plane will pass | the line direction | |
| | | through C1 and | from the first | |
| | | P2. | point to the | |
| | | Projected | second point and | |
| | | entity: None | normal of the | |
| | | | plane is closest to | |
| | | | the normal of the | |
| | | | principal plane, | |
| | | | having the | |
| | | | longest projection | |
| | | | of the line. | |
| | | | Projected | |
| | | | entity: none | |

| | | |
|---|---|---|
| Tangent T | PT | TT |
| | 1. If C2 is planar | For a line only |
| | Point: P1 | planar curve is |
| | Normal: Normal of the plane of C2 | allowed as the |
| | Projected entity: C2 | first tangent |
| | 2. If C2 is a 3d curve, | constraint. |
| | Point: Point | Second tangent |
| | Normal: Same as inferred by the first | constraint may |
| | point | be a planar or |
| | Projected entity: C2 | a 3d curve. In |
| | | both the cases, |
| | | the support |
| | | plane will be |
| | | the plane in |
| | | which the first |
| | | planar curve |
| | | lies Projected |
| | | entity: second |
| | | constraint |
| Normal N | PN | No option |
| | Point: Picked point | |
| | Normal: Normal of the support plane is | |
| | the cross product of vector (vector from | |
| | first point to intersection point between | |
| | normal from first point to plane and plane) | |
| | and u direction tangent at intersection | |
| | point. In the case of a curve it is the cross | |
| | product of vector (vector from the first | |
| | point to the picked point on the curve) and | |
| | tangent direction at the picked point on the | |
| | curve. If the point lies on the plane or the | |
| | line, the vector will be normal of the plane | |
| | or curve. | |
| | Projected entity: None | |
| Angle A | PA | TA |
| | 1. Support plane will pass through the | Support plane |
| | point and the line picked for the angle | will be the |
| | constraint. Projected entity: None | same as |
| | 2. If point lies on the line then | inferred by the |
| | Point: Offset point (offset the point | first Tangent |
| | from the line picked for angle constraint | constraint |
| | in existing inferred support plane) | |
| | Normal: The plane passes through the | |
| | line picked for the angle constraint and | |
| | the normal of the plane is closest to the | |
| | normal of the principal plane, having | |
| | the longest projection of the line. | |
| | Projected entity: P1 | |
| X, Y, Z | PX or PY or PZ | TX or TY or |
| | Point: Point picked for first constraint | TZ |
| | Normal: If x or y is the second constraint | Support plane |
| | then plane's normal will be z and if z is | will be the |
| | second constraint then plane's normal be x | same as |
| | Projected entity: None | inferred by the |
| | | first Tangent |
| | | constraint |

However, it is obvious to those skilled in the art of CAD design how to define a plane utilizing overt selection methods, for example a double mouse button click.

Once the support plane is defined or auto-inferred, or the support plane is defined and locked by the user (Step 320) the function then determines whether it is necessary to project the object onto the support plane (Step 326), and continuing on to actually project the object onto the support plane (Step 322), before the second constraint is created (Step 328). And if no object needs projection onto the support plane, the single curve function creates the second constraint (Step 328).

Again, it is important to note that the user continues to have the option to redefine any of the above defined and/or inferred components (Step 330). After the first constraint is created, the user has the option to define the support plane (Step 332), where objects are projected and constraints are revalidated. Further, the user can include additional elements (Step 334) for example options and limits that also define a plurality of attributes for the created line. And finally, the user then applies the steps above to create the line based on associative constraints (Step 336).

3. An example of the Presently Preferred Embodiment for Line Creation

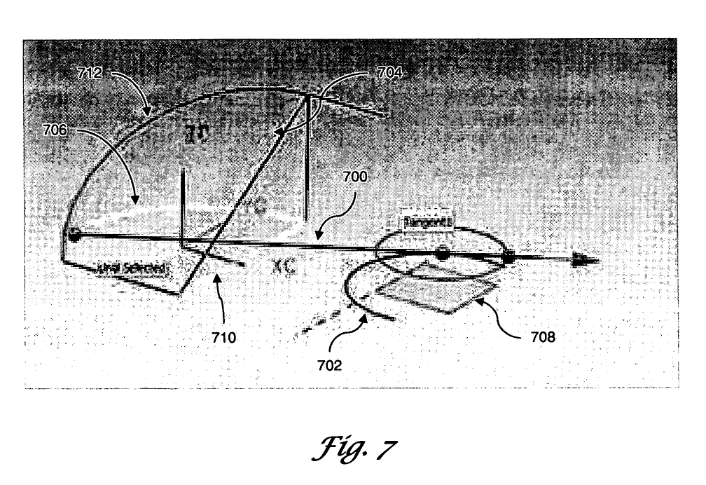

Following the above flow chart and associated tables, the designer intends to create a line 700 that is tangent to an arc 702, at an angle to a 3D line 704 and stops at a projected 3D arc 706, as illustrated in FIG. 7. The designer places the first constraint as the tangent to the arc 702. Referring to Table 3, the inferred support plane is the normal of the plane of the curve, with an inferred support plane 708. Next, the designer defines the second constraint as an angle to the 3D line 704, where the 3D line 704 is projected to the current inferred support plane indicated by a projected 3D line 710, to define the second constraint angle of 120 degrees. Referring to Table 4, the current design satisfies the TA (tangent/angle) condition, which results in the inferred support plane 708 as the same as inferred by the first tangent constraint. And finally, for a limit, or extent, to a selected object, an already present arc 712 projected onto the inferred support plane 708, with the projected 3D arc 706.

B. Center-Based Arc/Circle Creation

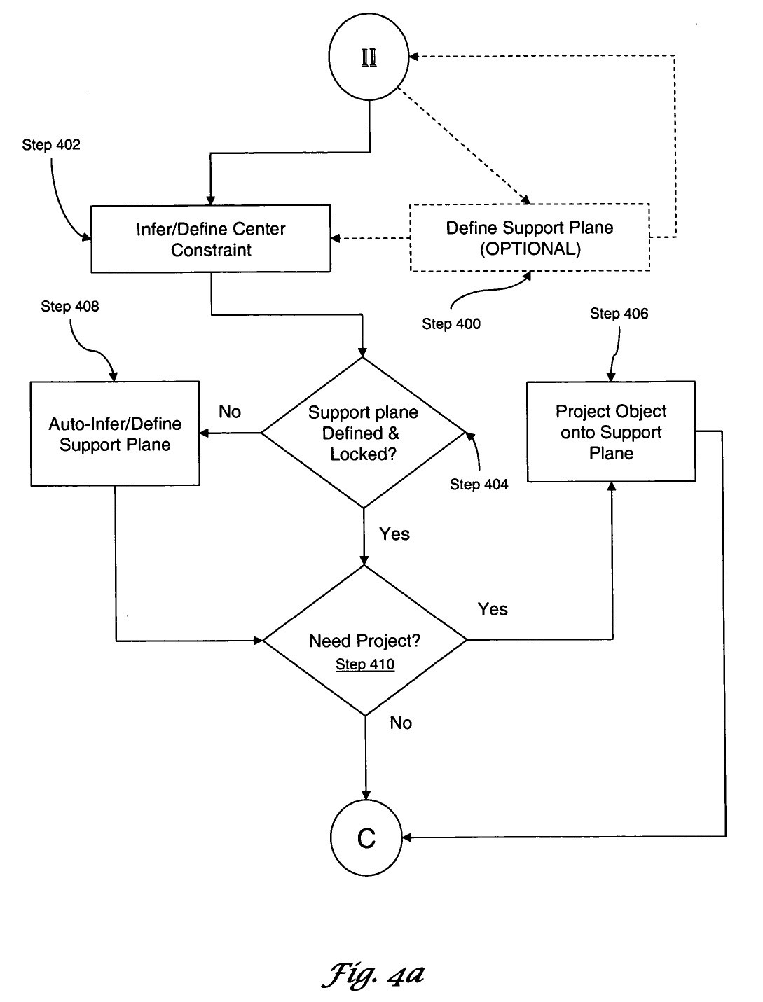

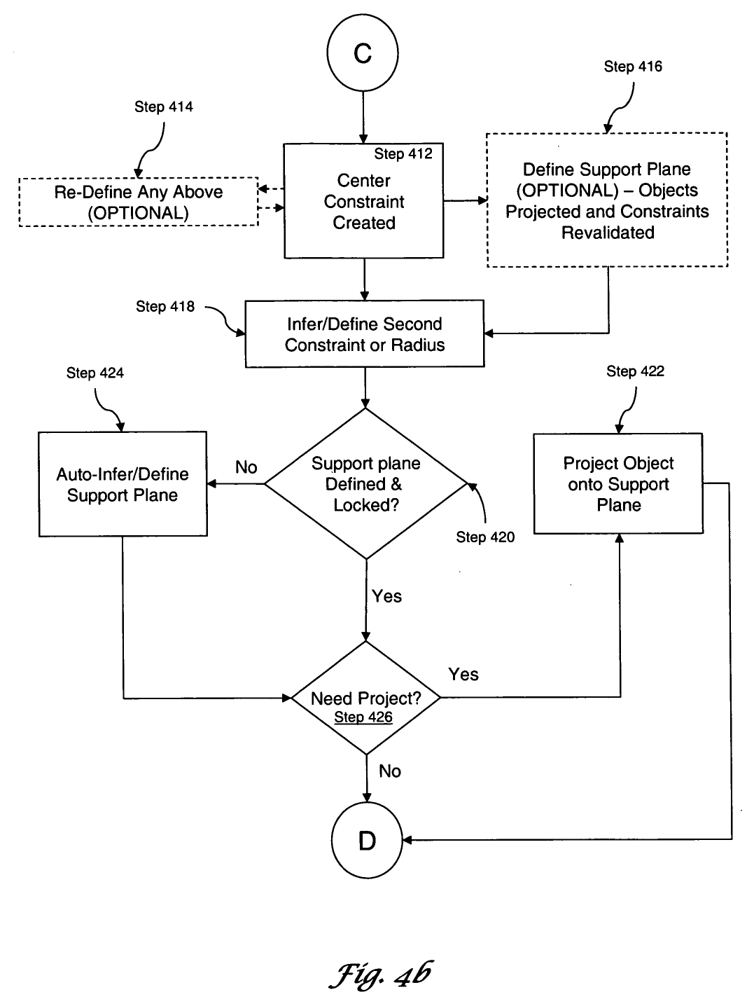

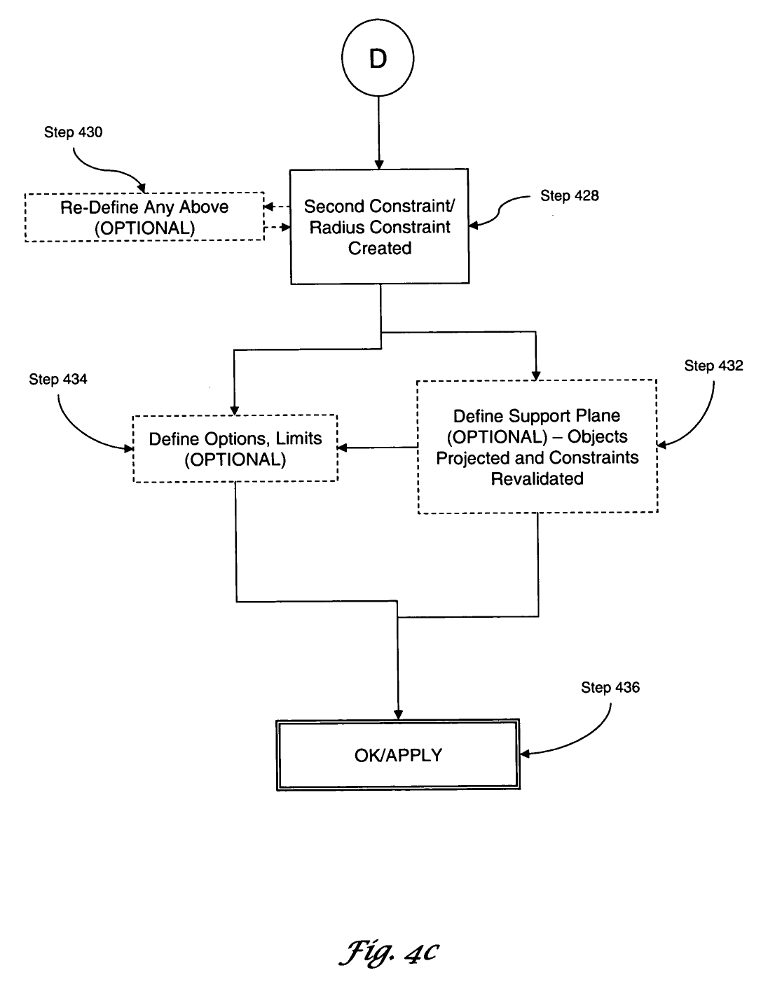

Turning to FIGS. 4a-4c, a series of flow charts for center-based arc/circle creation, where center-based arc/circle creation includes inferring or defining a plurality of curve components, and those curve components are at least one constraint, and one support plane. Regardless, the curve components can be defined or inferred at any stage of the curve creation that is feasibly possible, and can likewise be edited at anytime before curve creation.

1. Creating the First Constraint

It is optional to define the support plan at the beginning (Step 400), however, a center constraint must initially be inferred or defined (Step 402). A defined center constraint is one that is selected by the user in methods commonly known in the industry for selecting centers, and or features, in CAD programs. Formation of an inferred center will be discussed in more below in the discussion at II.D, Auto-Inferred Constraints, infra.

If the support plane is not defined and locked (Step 404), single curve function auto-infers or defines the support plane (Step 408). The auto-inferring of the support plane after the first constraint is supplied for the center-based arc/circle operation is illustrated more fully by use of the heuristics in the following decision table, TABLE 5 where again, the inferred support plane is defined by at least a point and a normal.

TABLE 5

| Constraint | First pick | Inferred support plane |
|---|---|---|
| Point P | 1. Point in space, Existing | Point: Picked point |
| | Point or Point by | Normal: Normal of the principal |
| | coordinates | plane (XY, YZ or ZX) which is |
| | | the most parallel to |
| | | the screen. |
| | | Projected entity: None |
| | 2. Point on a line or a | Point: Point on a line or a |
| | Linear Edge | linear edge |
| | | Normal: The plane passes |
| | | through the picked line. The |
| | | normal of the plane is closest to |
| | | the normal of the principal |
| | | plane, having the longest |
| | | projection of the line. |
| | | Projected entity: None |
| | 3. Point on an arc or any | Point: Point on an arc |
| | planar curve, or a linear | Normal: Normal of the plane of |
| | curve | the curve |
| | | Projected entity - None |
| | 4. Point on a 3D spline, | Point: Point on a 3D spline |
| | End point of a 3D | Normal: Curve normal at that |
| | spline, Knot point of | point |
| | a 3D spline | Projected entity: None |
| | 5. Point on a 3D face or a | Point: Point on a 3D face |
| | Planar face | Normal: Face normal direction |
| | | at that point |
| | | Projected entity: None |
| Tangent T | 1. Planar object picked. | Point: Location on curve |
| | | Normal: The normal of the |
| | | plane of the curve. |
| | | Projected entity: None |
| | 2. Point on a line, Mid | Point: Point on a linear curve |
| | point of a line, | Normal: The plane passes |
| | endpoint of a line | through the picked line and the |
| | or Point on a Linear | normal of the plane is closest to |
| | Edge or Curve | the normal of the principal |
| | | plane, having the longest |
| | | projection of the line. |
| | 3. Non planar object | Cannot infer the plane. A 3d |
| | picked. | curve cannot be picked as the |
| | | first tangent constraint. |

However, if is obvious to those skilled in the art of CAD design how to define a plane utilizing overt selection methods.

Once the support plane is defined or auto-inferred, or the support plane is defined and locked by the user (Step 404) the function then determines whether it is necessary to project the object onto the support plane (Step 410), and continuing on to actually project the object onto the support plane (Step 406), before the center constraint is created (Step 412). And if no object need projection onto the support plane, then the single curve function creates the center constraint (Step 412). It is important to note that the user continues to have the option to redefine any of the above defined and/or inferred components (Step 414).

2. Creating the Second Constraint

After the first constraint is created, the user has the option to define the support plane (Step 416), where objects are projected and constraints are revalidated. Should the user not define the support plane, a second constraint or radius is then defined or inferred (Step 418). The defining of the second constraint or radius is accomplished by the same overt method for selection as commonly understood in the industry. And the inference of the second constraint or radius is accomplished by the method discussed in more detail at II.D, Auto-Inferred Constraints, infra.

Continuing on, if the support plane is not defined and locked (Step 420), the single curve function auto-infers or defines the support plane (Step 424). The auto-inferring of the support plane after the second constraint is supplied for the center-based arc/circle operation is illustrated more fully by use of the heuristics in the following decision table, Table 6 where P2 is the second point picked, C1 is the first constraint, C2 is the second constraint, and the inferred support plane is defined by at least a point and a normal:

TABLE 6

| | | Inferred plane when first | | |
|---|---|---|---|---|
| | | constraint is point | | Inferred plane |
| | | Point on Line or | | when first |
| Second | | Point on Linear | | constraint is |
| Constraint Pick | | Edge | All remaining cases | tangent |
| Point P | Point on Line or | 1. If the point | 1. If the point | TP |
| | Point on | lies in the | lies in the | 1. If C1 is |
| | Linear Edge | present | present | planar |
| | | inferred | inferred plane | Point: point |
| | | plane then | then support | on C1 |
| | | the support | plane will | Normal: The |
| | | plane will | remain | normal of the |
| | | remain | unchanged. | plane of C1. |
| | | unchanged. | Projected | Projected |
| | | Projected | entity: None | entity: P2 |
| | | entity: None | 2. (a) If P1 does | 2. If C1 is a 3d |
| | | 2. If P2 does | not lie on C2, | curve: |
| | | not lie on C1, | then support | When the first |
| | | then support | plane will pass | object is a 3d |
| | | plane will | through P1 | curve, it |
| | | pass through | and C2. | cannot be picked |
| | | C1 and P2. | Projected | |
| | | Projected | entity: None | 3. If C1 is linear |
| | | entity: None | (b) If P1 lies | (a) If P2 does |
| | | | on the C2, | not lie on C1 |
| | | | then: | then support |
| | | | Point: point | plane will pass |
| | | | on C2 | through C1 |
| | | | Normal: The | and P2. |
| | | | plane passes | Projected |
| | | | through C2 and | entity: None |
| | | | the normal of | (b) If P2 lies |
| | | | the plane is | on C1 |
| | | | closest to the | Point: Offset |
| | | | normal of the | point (offset |
| | | | principal plane, | the point from |
| | | | having the | C1 in existing |
| | | | longest | inferred |
| | | | projection of | support plane) |
| | | | C2. | Normal: The |
| | | | Projected | normal of the |
| | | | entity: P1 | plane most |
| | All | 1. If the point | 1. If the point lies | parallel to the |
| | remaining | lies in the | in the present | screen and |
| | cases | present | inferred plane | contains C1 |
| | | inferred | then the | Projected |
| | | plane then | support plane | entity: P2 |
| | | the support | will remain | |
| | | plane will | unchanged. | |
| | | remain | 2. Point: First | |
| | | unchanged. | point | |
| | | 2. If P2 does | Normal: The | |
| | | not lie on C1, | plane passes | |
| | | then support | through the line | |
| | | plane will | direction from | |
| | | pass through | first point to | |
| | | C1 and P2. | second point | |
| | | Projected | and the normal | |
| | | entity: None | of plane is | |
| | | | closest to the | |
| | | | normal of the | |
| | | | principal plane, | |
| | | | having the | |
| | | | longest | |
| | | | projection of the | |
| | | | line. | |
| | | | Projected | |
| | | | entity: None | |

| | | |
|---|---|---|
| Tangent T | PT | TT |
| | 1. If C2 is planar | 1. If C1 is |
| | Point: P1 | planar, |
| | Normal: The normal of the plane | Support Plane |
| | of C2. | will be the |
| | Projected entity: C2 | plane of C1, |
| | 2. If C2 is a 3d curve, | Projected |
| | Point: P1 | entity: none |
| | Normal: Same as inferred by the | 2. If C1 and C2 |
| | first point | are linear and |
| | Projected entity: C2 | both lie in the |
| | 3. If C2 is linear | same plane, |
| | (a) If P1 does not lie on C2 then | Support Plane |
| | support plane will pass through | will be that |
| | P1 and C2. | plane, |
| | (b) If P1 lies on C2 | Projected |
| | Point: offset point (offset the | entity: none |
| | point from C2 in existing | 3. If C2 is |
| | inferred support plane) | planar, C1 is |
| | Normal: plane passes through | linear and lies |
| | C2 and normal of plane is closet | in the plane |
| | to the normal of principal plane, | of C2, |
| | having longest projection of the | support plane |
| | C2 | will be the |
| | Projected entity: P1 | plane of C2, |
| | | Projected |
| | | entity: C1 |
| | | 4. For remaining |
| | | cases support |
| | | plane will be |
| | | the plane |
| | | inferred by |
| | | first Tangent |
| | | constraint. |
| | | Projected |
| | | entity: |
| | | second |
| | | constraint |

However, it is obvious to those skilled in the art of CAD design how to define a plane utilizing overt selection methods.

Once the support plane is defined or auto-inferred, or the support plane is defined and locked by the user (Step 420) the function then determines whether it is necessary to project the object onto the support plane (Step 426), and continuing on to actually project the object onto the support plane (Step 422), before the second constraint is created (Step 428). And if no object needs projection onto the support plane, then the single curve function creates the second constraint (Step 428).

Again, it is important to note that the user continues to have the option to redefine any of the above defined and/or inferred components (Step 430). After the first constraint is created, the user has the option to define the support plane (Step 432), where objects are projected and constraints are revalidated. Further, the user can include additional elements (Step 434) for example options and limits that also define a plurality of attributes for the created line. And finally, the user then applies the steps above to create the center-based arc/circle based on associative constraints (Step 436).

3. An example of the Presently Preferred Embodiment for Center-Based Arc/Circle Creation

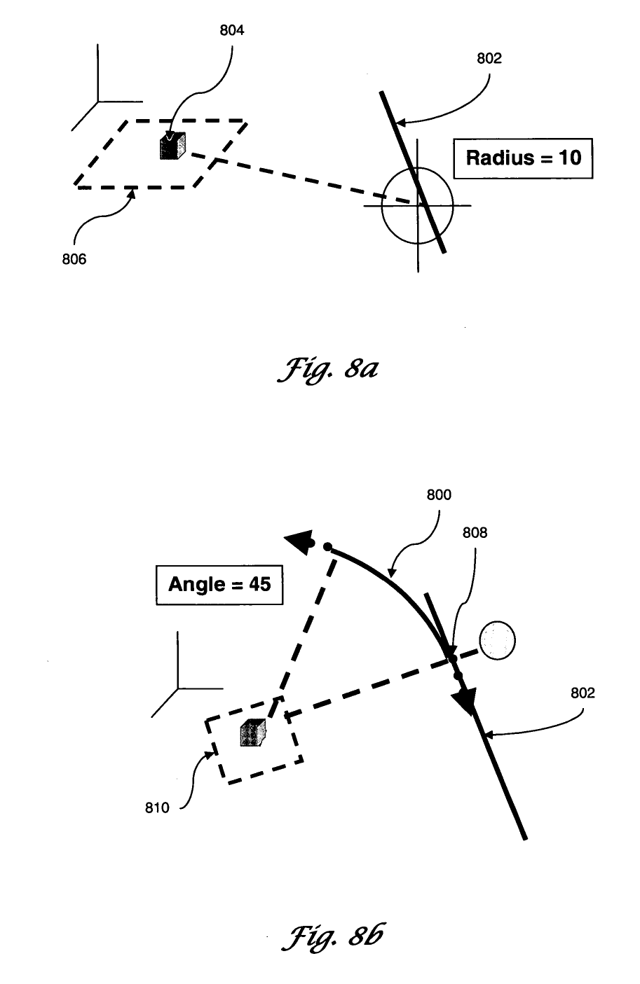

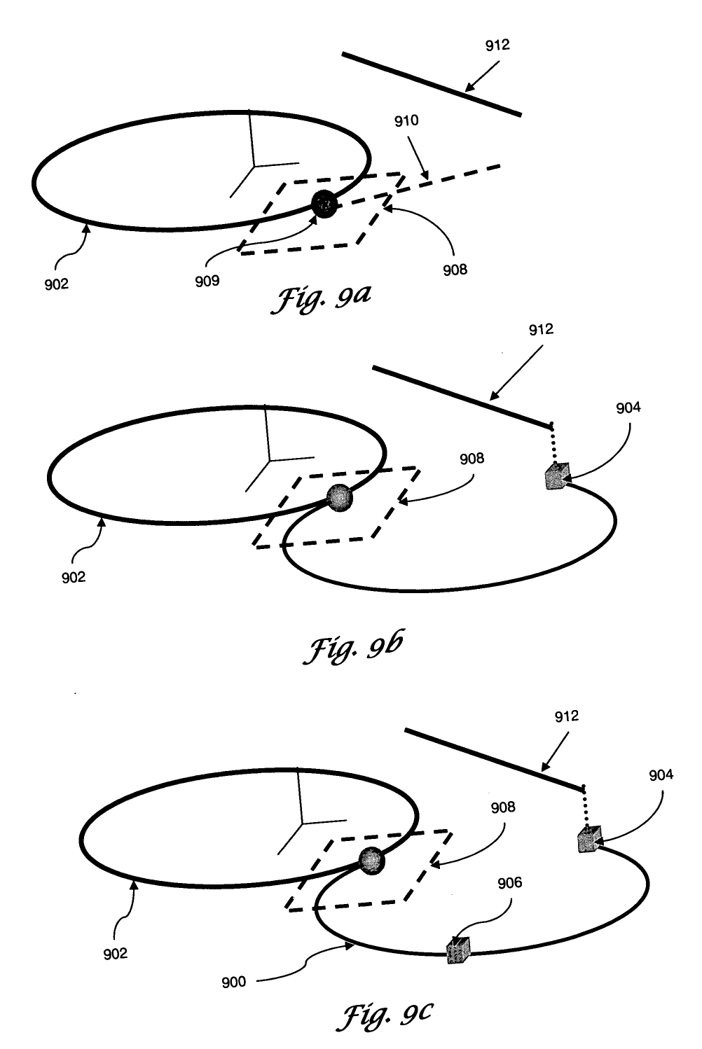

Following the above flow chart and associated tables, the designer intends to create a center-based arc 800 constrained to the tangent of a line 802, as illustrated in FIG. 8a and FIG. 8b. To begin, the designer selects a center-point 804 and initially defines a radius, for example, of 10. Based on Table 5, above, an inferred support plane 806 is normal to the principal plane that is the most parallel to the screen. Next, the designer constrains the center-based arc 800 such that the line 802 is tangent to the center-based arc 800 at a tangent point 808. Referring to Table 6, the current design satisfies the PT (point/tangent) condition for the creation of a center-based arc/circle, where the constraint, C2, i.e. the tangent point 808, is linear, such that if the center-point 804 does not lie on C2, a new inferred support plane 810 passes through the center-based point and C2.

C. 3-Point Arc/Circle Creation

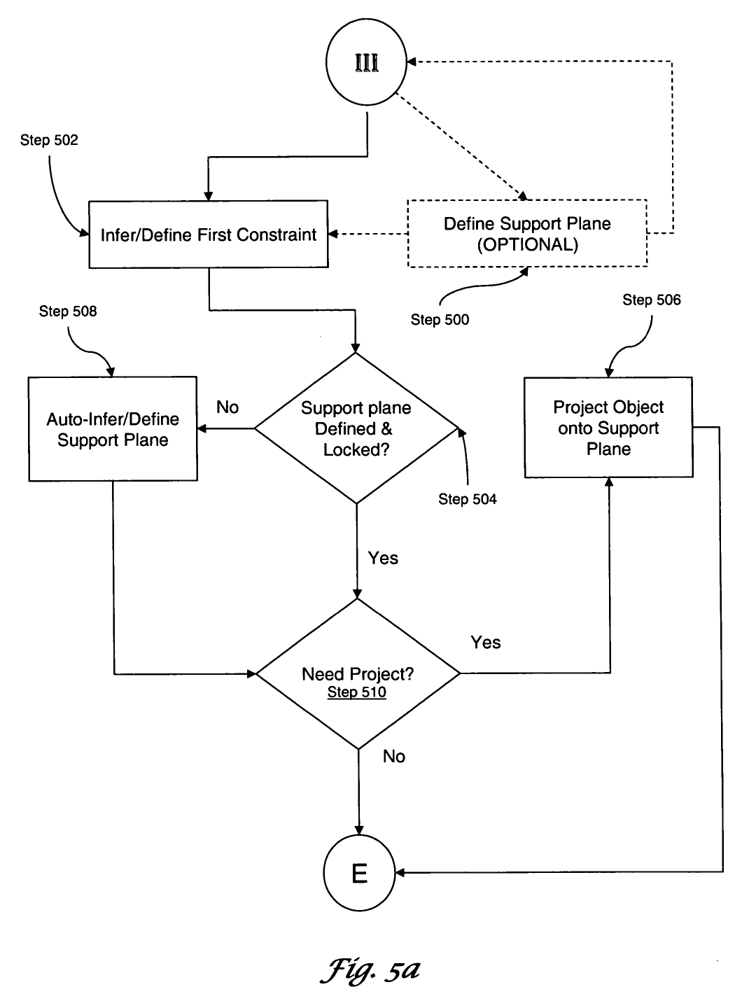

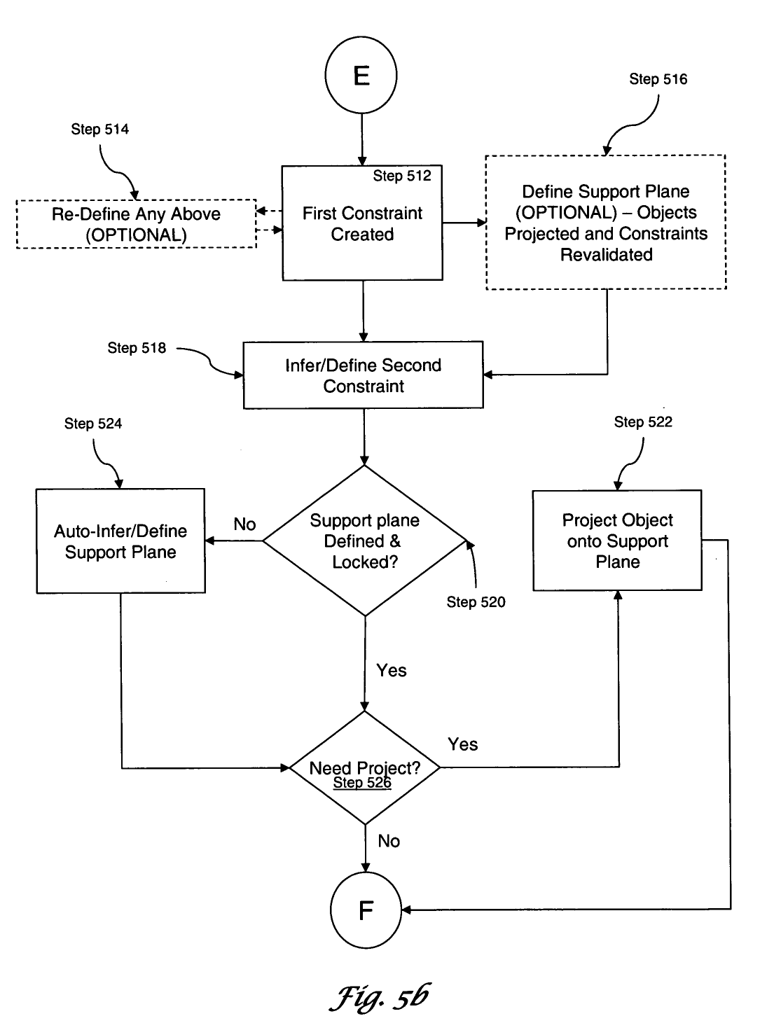

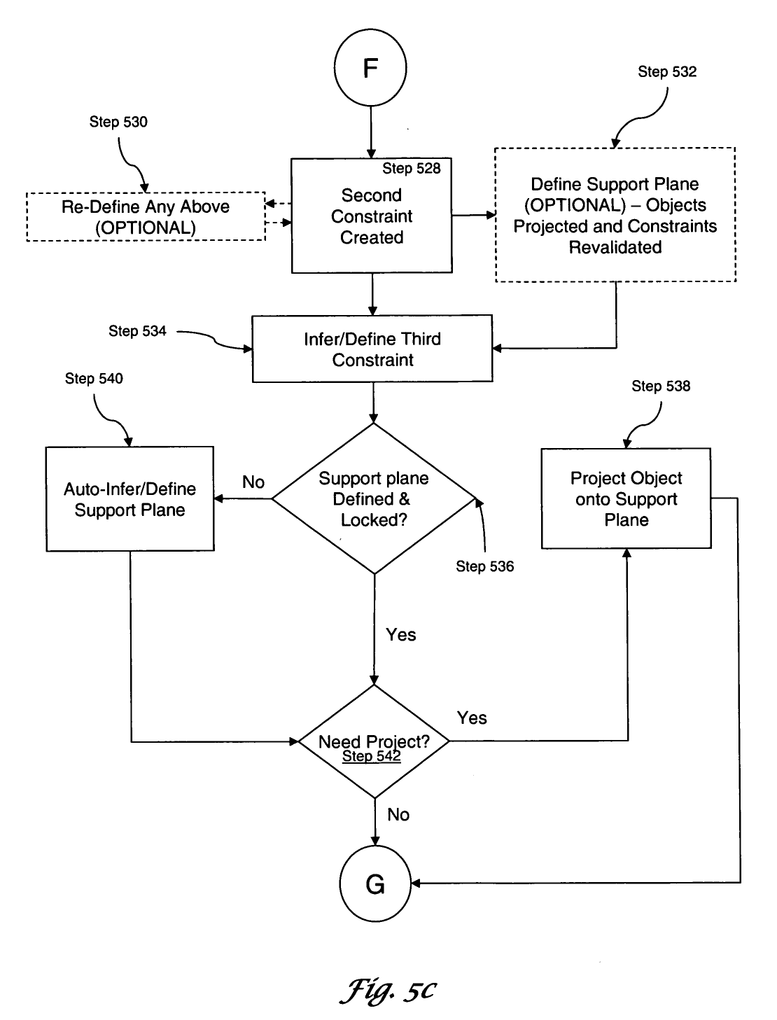

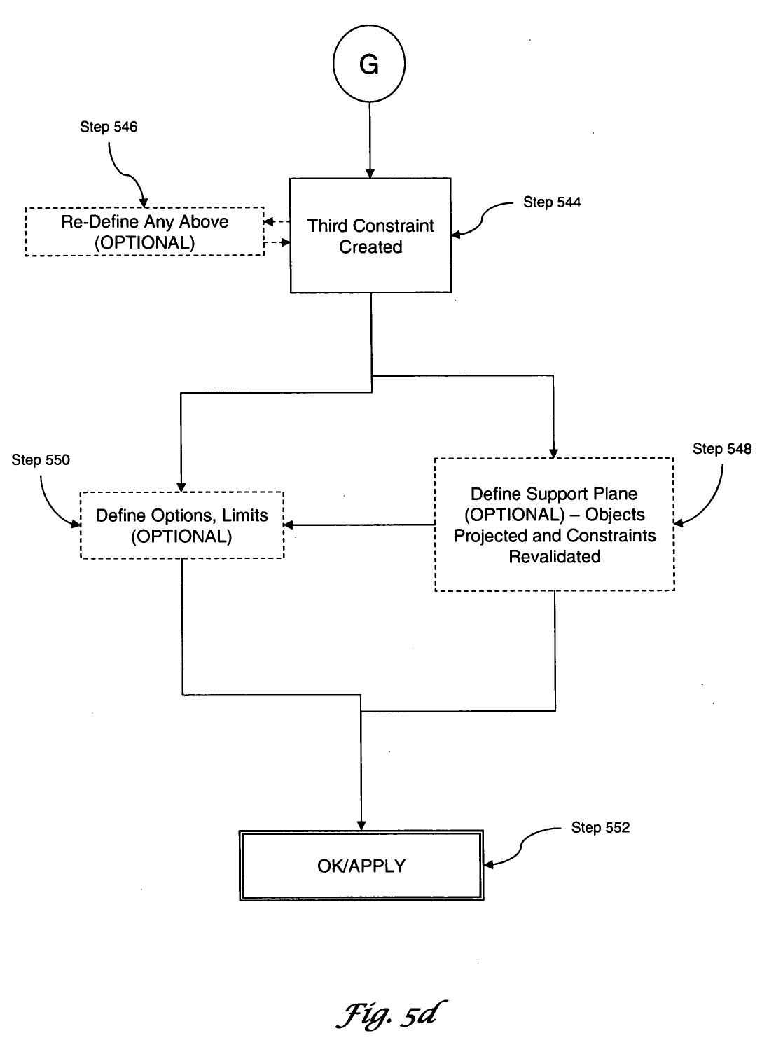

Turning to FIGS. 5a-5d, a series of flow charts for 3-point arc/circle creation, where 3-point arc/circle creation includes inferring or defining a plurality of curve components, and those curve components are at least one constraint, and one support plane. Regardless, the curve components can be defined or inferred at any stage of the curve creation that is feasibly possible, and can likewise be edited at anytime before curve creation.

1. Creating the First Constraint

It is optional to define the support plane at the beginning (Step 500), however, a first constraint must initially be inferred or defined (Step 502). A defined constraint is one that is selected by the user in methods commonly known in the industry for selecting objects, and or features, in CAD programs. Formation of an inferred constraint will be discussed at II.D, Auto-Inferred Constraints, infra.

If the support plane is not defined and locked (Step 504), the single curve function auto-infers or defines the support plane (Step 508). The auto-inferring of the support plane after the first constraint is supplied for the 3-point arc/circle operation is illustrated more fully by use of the heuristics in the decision table, TABLE 3, supra. However, if is obvious to those skilled in the art of CAD design how to define a plane utilizing overt selection methods.

Once the support plane is defined or auto-inferred, or the support plane is defined and locked by the user (Step 504) the function then determines whether it is necessary to project the object onto the support plane (Step 510), and, if so, to actually project the object onto the support plane (Step 506), before the first constraint is created (Step 512). And if no object need projection onto the support plane, then the single curve function creates the first constraint (Step 512). It is important to note that the user continues to have the option to redefine any of the above defined and/or inferred components (Step 514).

2. Creating the Second Constraint

After the first constraint is created, the user has the option to define the support plane (Step 516), where objects are projected and constraints are revalidated. Should the user not define the support plane, a second constraint is then defined or inferred (Step 518). The defining of the second constraint is accomplished by the same overt method for selection as commonly understood in the industry. And the inference of the second constraint is accomplished by the method discussed at II.D, Auto-Inferred Constraints, supra.

If the support plane is not defined and locked (Step 520), the single curve function auto-infers or defines the support plane (Step 524). The auto-inferring of the support plane after the second constraint is supplied for the center-based arc/circle operation is illustrated more fully by use of the heuristics in the following decision table, Table 4, supra. However, it is obvious to those skilled in the art of CAD design how to define a plane utilizing overt selection methods.

Once the support plane is defined or auto-inferred, or the support plane is defined and locked by the user (Step 520) the function then determines whether it is necessary to project the object onto the support plane (Step 526), and, if so, to actually project the object onto the support plane (Step 522), before the second constraint is created (Step 528). If no object needs projection onto the support plane, then the single curve function creates the second constraint (Step 528). It is important to note that the user continues to have the option to redefine any of the above defined and/or inferred components (Step 530).

3. Creating the Third Constraint

After the second constraint is created, the user has the option to define the support plane (Step 532), where objects are projected and constraints are revalidated. Should the user not define the support plane, a third constraint is then defined or inferred (Step 534). The defining of the third constraint is accomplished by the same overt method for selection as commonly understood in the industry. And the inference of the third constraint is accomplished by the method discussed at II.D, Auto-Inferred Constraints, infra.

If the support plane is not defined and locked (Step 536), the single curve function auto-infers or defines the support plane (Step 540). The auto-inferring of the support plane after the third constraint is supplied for the 3-point arc/circle operation is illustrated more fully by use of the heuristics in the following decision table, Table 7 where P2 is the second point picked, C1 is the first constraint, C2 is the second constraint, and the inferred support plane is defined by at least a point and a normal:

TABLE 7

| | |
|---|---|
| PPP | Support Plane will pass through three points; user error if points |
| | are collinear. |
| PPT | 1. If the C3 is planar |
| | Point: P1 |
| | Normal: Normal of plane of C3. |
| | Projected entity: P2 and C3 |
| | 2. If C3 is a 3d curve, |
| | Support plane will be same as inferred by PP, |
| | Projected entity: C3 |
| | 3. If C3 is linear |
| | (a) if P1 and P2 lies on C3, then user error |
| | (b) if P1 lies on C3 and P2 is not, Support Plane will pass |
| | through P2 and C3 and projected entity: P1 |
| | (c) If P1 does not lie on C3 and P1, P2 and C3 lie on the plane. |
| | Support Plane will pass through P1 and C3 and projected entity: |
| | P2 |
| | (d) if P1, P2 and C3 do not lie on a plane then Support Plane |
| | will be inferred by P1 and P2 and projected entity: C3 |
| PTP | 1. If C2 is planar |
| | Point: P1 |
| | Normal: Normal of the plane of C2. |
| | Projected entity: C2 and P3 |
| | 2. If C2 is a 3d curve, |
| | Point: P1 |
| | Normal: Same as inferred by the first point |
| | Projected entity: C2 and P3 |
| | 3. If C2 is linear |
| | (a) if P1 lies on C2 and P3 does not lie on C2 then Support |
| | Plane will be pass through C2 and P3. |
| | Projected entity: P1 |
| | (b) if P1 and P3 lie on C2 then Arc is not possible |
| | (c) For remaining cases Support Plane will pass through P1 and |
| | C2 and Projected entity: P3 |
| PTT | 1. If C2 is planar |
| | Point: P1 |
| | Normal: Normal of plane of C2. |
| | Projected entity: C2 and C3 |
| | 2. If C2 is a 3d curve, |
| | Point: P1 |
| | Normal: Same as inferred by the first point |
| | Projected entity: C2 and C3 |
| | 3. If C2 is linear |
| | (a) if P1 lies on C2 and C3 Arc is not possible |
| | (b) if P1 do not lies on C2 then Support Plane will pass through |
| | P1 and C2. |
| | Projected entity: C3 |
| | (c) If P1 lies on C2 and if C3 is linear, support plane will pass |
| | through C2 and C3. |
| | Projected entity: P1 |
| | (d) If P1 lies on C2 & if C3 is planar then |
| | Point: P1 |
| | Normal: Normal of plane of C3 |
| | Projected entity: C2, C3 |
| TPP | 1. If C1 is planar |
| | Point: Point on planar curve |
| | Normal: Normal of the plane in which C1 lies. |
| | Projected entity: P2 and P3 |
| | 2. If C1 is a 3d curve, |
| | Cannot pick 3d curve as the first curve |
| | 3. If C1 is linear |
| | (a) if P2 lies on C1 support plane will be pass through C1 and |
| | P3 and projected entity: P2 |
| | (b) if P3 lies on C1 support plane will be pass through C1 and |
| | P2 and projected entity: P3 |
| TPT | 1. If C1 is planar |
| | Point: Point on planar curve |
| | Normal: Normal of the plane of C1. |
| | Projected entity: P2 and C3 |
| | 2. If C1 is a 3d curve, |
| | Cannot pick a 3d curve as the first curve |
| | 3. If C1 is linear |
| | (a) If P2 does not lie on C1 support plane will be pass through |
| | C1 and P2 and projected entity: C3 |
| | (b) If P2 lies on C1 and C3 is linear then support plane will be |
| | pass through C1 and C3 and projected entity: P2 |
| | (c) If P2 lies on C1 and C3 is planer |
| | Point: C3 |
| | Normal: Normal of plane of C3. |
| | Projected entity: C1 and P2 |
| | (d) If P2 lies on C1 and C3 is a 3d curve |
| | Point: Point on C1 |
| | Normal: Plane passes through C1 and the normal of the plane is |
| | closest to the normal of principal plane, having the longest |
| | projection of C1. |
| | Projected entity: C3 |
| TTP | Support Plane will same as by TT |
| TTT | Support Plane will same as by TT |

However, it is obvious to those skilled in the art of CAD design how to define a plane utilizing overt selection methods.

Once the support plane is defined or auto-inferred, or the support plane is defined and locked by the user (Step 536) the function then determines whether it is necessary to project the object onto the support plane (Step 542), and continuing on to actually project the object onto the support plane (Step 538), before the third constraint is created (Step 544). And if no object needs projection onto the support plane, then the single curve function creates the third constraint (Step 544).

Again, it is important to note that the user continues to have the option to redefine any of the above defined and/or inferred components (Step 546). After the third constraint is created, the user has the option to define the support plane (Step 548), where objects are projected and constraints are revalidated. Further, the user can include additional elements (Step 550) for example options and limits that also define a plurality of attributes for the created 3-point arc/circle. Finally, the user applies the steps above to create the 3-point arc/circle with associative constraints (Step 552).

4. An example of the Presently Preferred Embodiment for 3-Point Arc/Circle Creation

Following the above flow chart and associated tables, the designer intends to create a 3-Point arc 900 constrained to the tangent of a circle 902, having a second constraint as a projected point 904, and finally defining an arc size with a second point 906 as a third constraint, as illustrated in FIG. 9a, FIG. 9b, and FIG. 9c. To begin, the designer selects a first constraint as tangent to the circle 902, and based on the above tables, an inferred support plane 908 is initially set through the plane of the circle 902. When the first constraint is set to a tangent constraint 909, the arc is previewed as a dashed line 910. Next when the designer selects the second constraint as a, end-point of a select line 912, that end-point is projected on the inferred support plane to the projected point 904. Referring to the tables above, with the TPx combination created thus far, the inferred support plane 908 remains. And lastly when placing the third and final constraint of the second point 906 to form the shape of the 3-point arc 900, the Table 7 is reference to determine the inferred support plane for the 3-point arc created with constraints TPP. Accordingly, since the projected point 904 lies on the inferred support plane 908 for the tangent constraint 909, C1, the inferred support plane 908 passes through the projected point 904, P2, the second point 906, P3, and the tangent constraint, C1.

D. Auto-Inferred Constraints

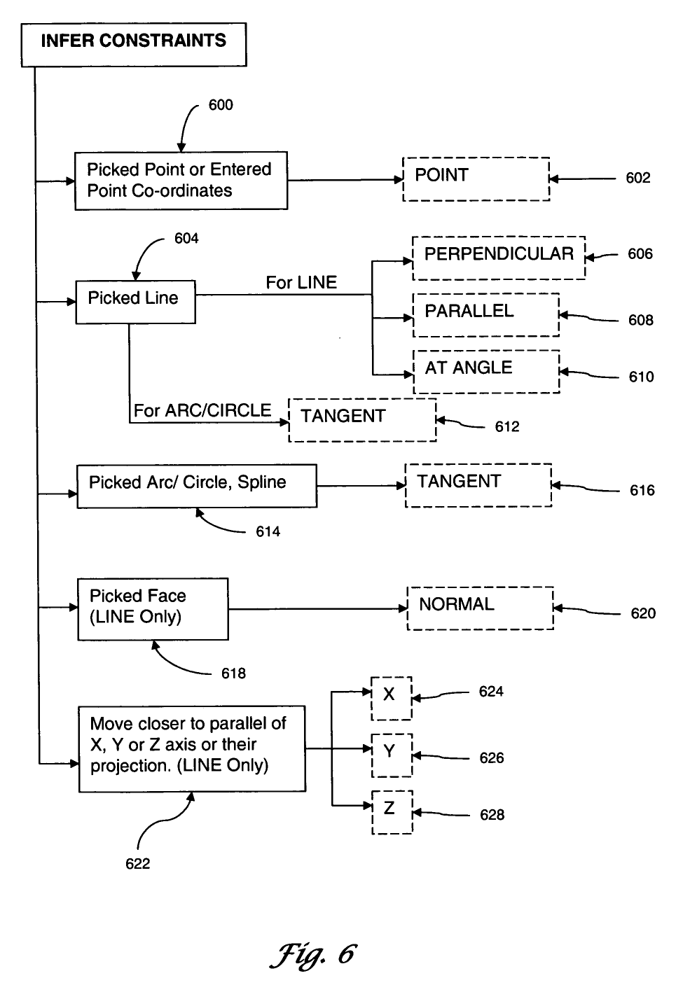

Turning now to FIG. 6, an indented tree structure illustrating auto-inferring of constraints, illustrating a path of inference computed by the preferred embodiment when the user fails to define the constraint. When the user initially selects a picked point or enters coordinates for a point 600, the inferred constraint is a selected point 602. The part of the process the user is in will dictate when picking an entire line what the inferred constraint will be. For example, when creating a new line, and the user picks a current line 604, such that the inferred constraint is either a perpendicular 606, a parallel 608, or an angle 610 to the current line. And when creating a arc/circle feature, the inferred constraint is a tangent 612 after the user picks the current line 604.

Likewise, when the user picks an arc/circle or a spline 614, the inferred constraint is a tangent to that arc, circle or spline 616. When the user creates a line and picks a feature face 618, the inferred constraint is a normal to that face 620. And finally, when a user initiates a line creation and moves a cursor closer to a parallel of the X, Y, or Z axis or a projection thereof 622, the inferred constraint is the X, Y, or Z axis, respectively 624, 626, 628.

III. Summary

This concludes the description of the preferred embodiment of the invention. The following describes some alternative embodiments for accomplishing the present invention. For example, the invention may be implemented in digital electronic circuitry, or in computer hardware, firmware, software, or in combinations thereof. An apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

The invention may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

The foregoing description of the preferred embodiment of the invention has been described for the purposes of illustration and description. It is not intended to be exhaustive or to limit the invention to the precise form disclosed. Many modifications and variations in the disclosed embodiment may occur to those skilled in the art once they learn of the basic inventive concepts. Therefore, it is intended that the scope of the invention be limited not by this detailed description, but rather by all variations and modifications as may fall within the spirit and the scope of the claims appended hereto.

What is claimed is:

1. A method for generating a curve on a three-dimensional axis, comprising the steps of:
receiving from a user at least one constraint,
interpreting at least one supporting object derived from said at least one constraint,
associating said at least one constraint with at least one reference geometry, and
defining a curve extent.

2. The method of claim 1, wherein said at least one supporting object is displayed and revisable by said user.

3. The method of claim 1, wherein there is one supporting object.

4. The method of claim 1, wherein said supporting object is a plane.

5. The method of claim 1, wherein said interpreting is at least one of inferred or defined.

6. A computer-program product tangibly embodied in a machine readable medium to perform a method for generating a three-dimensional curve, comprising:
instructions for receiving from a user at least one constraint, instructions for interpreting at least one supporting object derived from said at least one constraint,
instructions for associating said at least one constraint with at least one reference geometry, and
instructions for defining a curve extent.

7. The computer-program product of claim 6, wherein said supporting object is displayed and revisable by said user.

8. The computer-program product of claim 6, wherein there is only one supporting object.

9. The computer-program product of claim 6, wherein there is only one supporting object and it is a plane.

10. The computer-program product of claim 6, wherein said interpreting is at least one of inferred or defined.

11. A data processing system having at least a processor and accessible memory, comprising:
means for receiving from a user at least one constraint,
means for interpreting at least one supporting object derived from said at least one constraint,
means for associating said at least one constraint with at least one reference geometry, and
means for defining a curve extent.

12. The data processing system of claim 11, wherein said at least one supporting object is displayed and revisable by said user.

13. The data processing system of claim 11, wherein there is one supporting object.

14. The data processing system of claim 11, wherein said supporting object is a plane.

15. The data processing system of claim 11, wherein said interpreting is at least one of inferred or defined.

16. A method for generating a three-dimensional curve, wherein said curve is one of a line, an arc and a circle, comprising the steps of:
receiving from a user at least one constraint, wherein said at least one constraint is associated with at least one reference geometry, and said at least one constraint is one of inferred and defined,
creating a supporting plane that is displayed and revisable by the user from said at least one constraint, wherein said supporting plane is one of inferred and defined, and defining a curve extent.

17. A computer-program product tangibly embodied in a machine readable medium to perform a method for generating a three-dimensional curve, wherein said curve is one of a line, an arc and a circle, comprising:
instructions for receiving from a user at least one constraint, wherein said at least one constraint is associated with at least one reference geometry, and said at least one constraint is one of inferred and defined,
instructions for creating a supporting plane that is displayed and revisable by the user from said at least one constraint, wherein said supporting plane is one of inferred and defined, and
instructions for defining a curve extent.

18. A data processing system having at least a processor and accessible memory, comprising:
means for generating a three-dimensional curve, wherein said curve is one of a line, an arc and a circle, comprising the steps of:
receiving from a user at least one constraint, wherein said at least one constraint is associated with at least one reference geometry, and said at least one constraint is one of inferred and defined,
creating a supporting plane that is displayed and revisable by the user from said at least one constraint, wherein said supporting plane is one of inferred and defined, and
defining a curve extent.

19. A computer data signal for CAD/CAM modeling, said computer data signal comprising code configured to cause a designer to implement on a computer to employ a method comprising:
generating a three-dimensional curve, wherein said curve is one of a line, an arc and a circle, comprising the steps of:
receiving from a user at least one constraint, wherein said at least one constraint is associated with at least one reference geometry, and said at least one constraint is one of inferred and defined,
creating a supporting plane that is displayed and revisable by the user from said at least one constraint, wherein said supporting plane is one of inferred and defined, and
defining a curve extent.
